(19) United States
(12) Patent Application Publication
(10) Pub. No.: US 2010/0189945 A1
(43) Pub. Date: Jul. 29, 2010

(54) DESICCANT PLASTIC COMPOSITION FOR A SHAPED ARTICLE

(76) Inventor: Jean-Pierre Giraud, Paris (FR)

Correspondence Address: GREENBERG TRAURIG, LLP, MET LIFE BUILDING, 200 PARK AVENUE, NEW YORK, NY, 10166, US

(21) Appl. No.: 11/916,153

(22) PCT Filed: Jun. 2, 2006
(86) PCT No.: PCT/US06/21439

§ 371 Date: Nov. 30, 2007

Related U.S. Application Data
(60) Provisional application No. 60/687,098, filed on Jun. 2, 2005.

(51) Int. Cl. B32B 1/08

(52) U.S. Cl. 428/36.9

(57) ABSTRACT

In one embodiment, the present invention is a shaped article comprising an injection molded desiccant plastic composition, wherein the shaped article is a cylinder with an outside diameter of at least about 8.00 mm, a wall thickness of at least about 0.4 mm and an overall length of at least about 50.0 mm, wherein the desiccant plastic composition comprises a desiccant and a base polymer of a thermoplastic, and wherein the resulting shaped article has properties including a moisture uptake rate of at least about 20 mg in 24 hour measured by the Desiccant Rate of Absorption Test Procedure and of a stiffness of at least about 25 Newtons measured by the Mechanical Resistance Control test method.

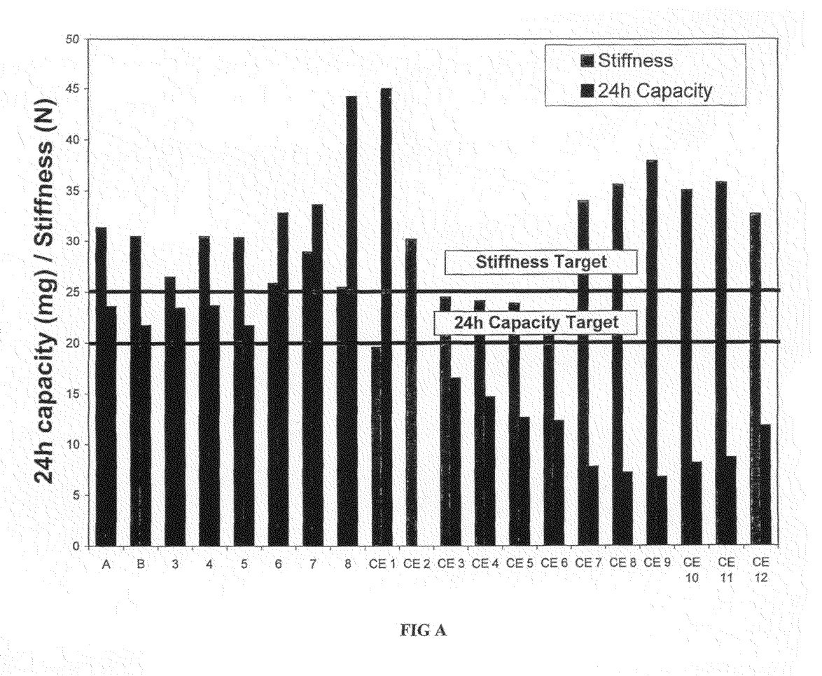

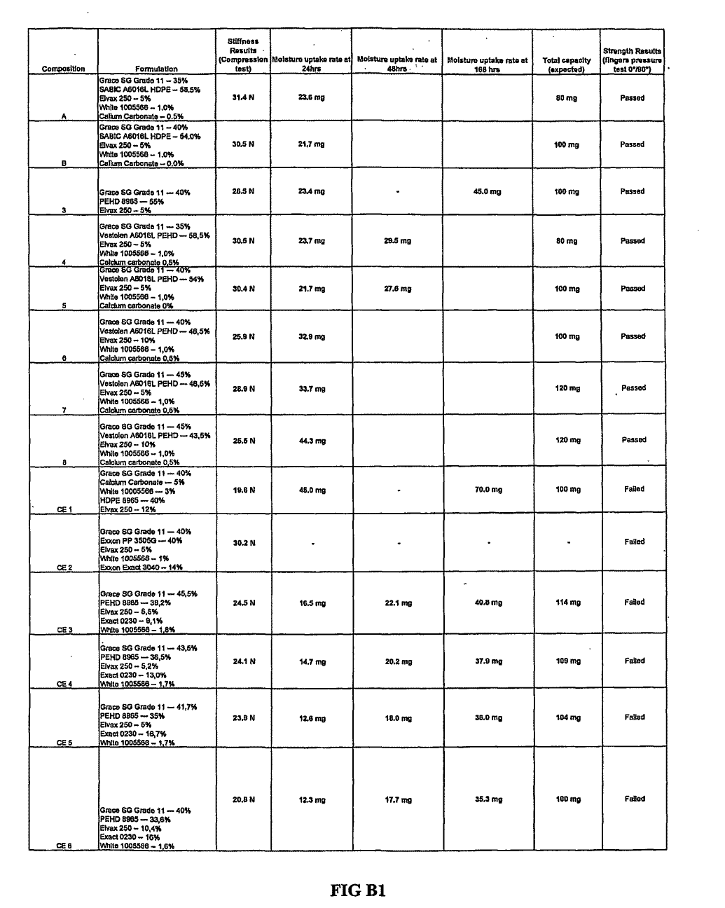

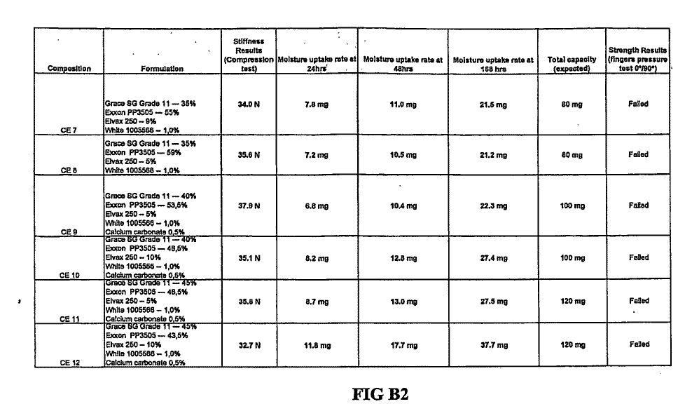

### BACKGROUND

Many products, such as diagnostic test strips, pharmaceuticals, medical devices and electronics are sensitive to environmental effects such as moisture. Desiccants are incorporated within product packages to scavenge moisture that enters the package during shelf life and to absorb any latent moisture in the product. Conventionally, desiccants are available in granular form and are packaged in a canister or sachet.

### BRIEF DESCRIPTION OF THE DRAWINGS

The following figures are merely illustrative of the present invention and are not meant to limit the invention to the embodiments shown in the figures.

FIG. A illustrates an embodiment of the present invention by graphing samples A and B and samples 3-8 and CE 1 through CE 12.

FIGS. B1 and B2 illustrate an embodiment of the present invention by detailing the samples for Examples 3-8 and comparative samples.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### SUMMARY OF THE INVENTION

In one embodiment, the present invention is a shaped article comprising an injection molded desiccant plastic composition, wherein the shaped article is a cylinder with an outside diameter of at least about 8.00 mm, a wall thickness of at least about 0.4 mm and an overall length of at least about 50.0 mm, wherein the desiccant plastic composition comprises a desiccant and a base polymer of a thermoplastic, and wherein the resulting shaped article has properties including a moisture uptake rate of at least about 20 mg in 24 hour measured by the Desiccant Rate of Absorption Test Procedure and of a stiffness of at least about 25 Newtons measured by the Mechanical Resistance Control test method.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

In one embodiment, the present invention is a desiccant plastic compositions that can be used to manufacture injection-molded articles that exhibit novel absorption and structural properties. For example, such novel structural and absorption properties include novel absorption kinetics (e.g., rate of moisture absorption) with novel mechanical strength to resists cracking or breaking. Examples of these packages include, but are not limited to, tablet dispensers, diagnostic strip dispensers and single unit rigid packaging (e.g., a custom container or non-cylindrical package).

In another embodiment, suitable desiccants, which can be used in the composition, include, but are not limited to, desiccants that obtain their moisture absorbing capabilities through physical absorption. The absorption process is accomplished because of a fine capillary morphology of the desiccant particles which pulls moisture therethrough. The pore size of the capillaries, as well as the capillaries' density determine the absorption properties of the desiccant. Examples of these physical absorption desiccants include molecular sieves, silica gels, clays and starches. Because these types of physical absorption desiccants are both inert and non-water soluble, they are preferred for many applications. Among other reasons, these innocuous characteristics are particularly compatible with food products and medicinal products that may be enclosed within containers formed from the desiccant entrained polymers, or at least exposed thereto. As stated previously, however, any of the three types may be employed within the polymer of the present invention for the purposes of producing a desiccant entrained polymer. Suitable desiccating agents include, but are not limited to, silica gel, molecular sieve, calcium carbonate and naturally occurring clay compounds, which would also include montmorillonite clay.

In another embodiment, the present invention includes one or more of the following: desiccant plastic compositions comprising formulations of the type exemplified in the examples, which are detailed below, that are used to mold shaped articles comprising 2-phase and 3-phase compositions. A 2-phase composition is one that consists of a desiccating agent and polymer. A 3-phase composition is one that consists of a desiccating and 2-immiscible polymers. In yet another embodiment, the shaped article is a cylinder with an OD of at least about 8.00 mm and a wall thickness of at least about 0.4 mm and an overall length of at least about 50.0 mm. The present invention also includes a 24-hour moisture uptake rate of the cylinder of at least about 20 mg in 24 hour measured by the “Desiccant Rate of Absorption Test Procedure” and a stiffness of the cylinder is at least about 25 Newtons measured by the “MECHANICAL RESISTANCE CONTROL” test method. In yet another embodiment, the composition comprises a base resin of HDPE with a tensile strength at yield of at least about 25 MPa measured using ISO 527-2, vinyl acetate content in the EVA used in the composition is about 18 to about 33%, and a desiccant of Silica Gel.

In one embodiment of the present invention, the loading of the desiccant can range from about 30 to about 50%, more particularly about 35 to about 45% (weight). In another embodiment, a base polymer is selected from a group of thermoplastics that include polyolefins polyethylene (LDPE, LLDPE, HDPE) and polypropylene may be used. Suitable 3-phase desiccant entrained plastic compositions include, but are not limited to, these desiccant plastics disclosed in U.S. Pat. Nos. 5,911,937, 6,214,255, 6,130,263, 6,174,952 and 6,124,006. These references are incorporated herein by reference. By varying the desiccant loading and channeling agent in the plastic formulation, the overall moisture capacity and uptake rate of the desiccant entrained plastic can be controlled.

In another embodiment, the desiccant entrained plastic composition enables the molding of intricately shaped articles with features of about 0.10-0.15 mm and wall thickness of about 0.2-0.4 mm and maintain mechanical tolerances to about +−0.02-0.04 mm. An injection molded cylindrical-shaped part with a length of 50.00 mm, outside Diameter of 8.20 mm and a wall thickness of 0.6 mm was used in this example. The part was composed of a desiccant plastic composition consisting of silica gel desiccant, HDPE, EVA-copolymer and calcium carbonate.

Suitable elastomers include, but are not limited to, styrene-butadiene rubbers (SER); styrene-ethylene-butadiene-styrene copolymers (SEES); butyl rubbers; ethylene-propylene rubbers (EPR); ethylene-propylene-diene monomer rubbers (EPDM); ethylene-vinyl acetate copolymers (EVA); ethyleneacrylate or butadiene-acrylonitrile; polynorbornenes; or indeed polyisoprenes; polychllroprenes; or polybutadienes.

The desiccant plastic compound was manufactured in an extrusion process and formed into continuous strands. These strands were cut into pellets that can be used in an injection molding process to manufacture a shaped article. The materials were compounded in a dry environment maintained at about 22 C/5% RH.

In one embodiment, the cylindrical shaped part had the following requirements:

1. Total Moisture Capacity-->about 80 mg measured by the “Desiccant Rate of Absorption Test Procedure.”

2. 24-hour Moisture Capacity-->about 20 mg measured at 22 C/80% RH measured by the “Desiccant Rate of Absorption Test Procedure.”

3. Stiffness-->about 25 N—Measured resistance of a rod applying a downward force to the cylindrical part measured by the “Mechanical Resistance Control” test-method.

4. Brittleness—no part cracks or breaks on resistance test setup.

5. Ability to form the parts in the mold without excessive flash or injection pressure. The following is the test method for “Mechanical Resistance Control.”

### Equipment:

Tension/Compression test rig <<Ultratest 1000N>>
Force gage <<AFG1000N>>
6 mm diameter compression rod
Part Support fixture

### Personal Computer

### Software <<Dataplot>>

### Instructions

1. Setup the Part support fixture and the AFG1000N force gage on the Ultratest 1000N test rig as shown on picture 1 and 2 and in such a manner that:
   the central axis of the compression rod is placed perpendicular to the central axis of a cap placed in the support fixture
   the central axis of the compression rod is placed at 4 mm±1 mm of the cap edge.
Setup the mechanical limit stops at the rear of the test rig on the <<G>> marks in such a manner that:
   the lower limit stop allows the movement of the compression rod down to the theoretical central axis of the cap.
   the upper limit stop allows a movement of the compression rod high enough for removing and inserting the cap in its support
2. Launch the <<Dataplot>> software on the personal computer
3. Create a new file and record the file name
4. Switch on the force gage and the test rig
5. Setup the speed of the test rig at 50 mm/min
6. Push the test starting pedal in order to bring the compression rod to the upper limit stop.
7. Insert the cap to be tested into the support fixture.
8. Reset the maximum force recorded in the force gage. Create a new measurement in the dataplot software.
9. Click on <<START>> on the screen to start the recording of the force data and push the pedal to start the descent of the compression rod.
10. When the force gage reaches the lower limit stop, the force gage goes automatically back to the upper limit stop. Click on <<STOP>> on the screen to stop the recording of the force data.
11. Print the curve on the screen
12. Record the maximum deflection force shown on the force gage.
13. Check at the aspect of the part tested, record and localize any stress cracks or part failure.
14. Insert a new part hi the support and repeat operations 8 to 14.
   The following is the test method for “Desiccant Rate of Absorption Test Procedure.”

### Equipment:

Weigh Dish: Aluminum dish used for weighing material on a balance.
Micro balance: Balance with accuracy to 1 microgram.
Environmental Chamber: Machine, which can control the humidity and temperature inside its chamber.

### Micro Balance or Analytical Balance

### Procedure or Instruction

### Procedure

Preset the calibrated Environmental Chamber to the required % Relative Humidity and temperature test conditions.
Label weigh dish to identify it with the material to be tested. If sample is sufficient in size, it may be labeled directly on the sample.
When sample is less than 2 grams, place weigh dish onto a calibrated microbalance and record weight of the dish to 1 microgram accuracy. Record results into a computer spreadsheet.
Press the tare on scale to remove weight of dish from balance or tare the analytical balance for samples greater than 2 grams in weight and record weight to the nearest 0.0001 grams.
Add material to be tested into weigh dish or on balance depending on sample size and place back on balance.
Record the weight of the material to the nearest microgram. Record results into a computer spreadsheet.
Place weigh dish with sample or sample into the preset environmental chamber.
Leave sample in chamber for required time.

The following examples are intended to be illustrative, and not restrictive. The samples were an injection molded cylindrical-shaped part with a length of 50.00 mm, outside Diameter of 8.20 mm and a wall thickness of 0.6 mm was used in this example. The part was composed of a desiccant plastic composition consisting of silica gel desiccant, HDPE, EVA-copolymer and/or calcium carbonate. “Elvax 250” is DuPont's Elvax 250—ethylene-vinyl acetate copolymer resin. “ME50005” is “Multibatch ME 50004” made by Multibase. “Polybatch 8160” is Polybatch white 8160 made by A. Schulman—a white masterbatch colorant. “M80063S” is Sabic HDPE M80063S made by Sabic—high density polyethylene for injection molding. “SG11” is silica gel adsorbent Grade 11 made by W.R. Grace & Co.

### Example #1

The following is the composition of samples A and 13 (weight basis).

| | |
|---|---|
| A | Grace SG Grade 11 - 35% |
| | Sabic A6016L HDPE - 58.5% |
| | Elvax 250 - 5% |
| | White 1005566 - 1.0% |
| | Calcium carbonate 0.5% |
| B | Grace SG Grade 11 - 40% |
| | Sabic HDPE - 54% |
| | Elvax 250 - 5% |
| | White 1005566 - 1.0% |
| | Calcium carbonate 0% |

FIG. A shows that samples A and B exhibit the novel stiffness and moisture uptake rate of the present invention. It is believed that the HDPE provides structural integrity to the part, the EVA (Elvax) enhances the moisture absorption, the White 1005566 is a colorant, and the Silica Gel is the desiccant.

### Example #2

The following is an example of another embodiment of the present invention. It is understood that, in another embodiment, “white masterbatch” may be eliminated. It is understood, in another embodiment, that the EVA amount may vary in the range of about 3% to about 10%, the CaCO3 amount may vary in the range of about 0.25% to about 1%.

| Material | | | Weight |
|---|---|---|---|
| Reference | Decription | Manufacturer | Percentage |
| M80063S | HDPE | SABIC | 57.62% |
| Polybatch 8160 | White masterbatch (60% | Schulman | 1.67% |
| | Ti02) - PE based | | |
| SG11 | Silica Gel grade 11 | Grace | 35% |
| ME50004 | CaCO3 Masterbatch | Multibase | 0.71% |
| | (70% CaC03) - PE based | | |
| Elvax 250 | EVA | Dupont | 5% |

### Examples 3-8 and Comparative Examples CE 1-CE 12

FIGS. B1 and B2 illustrate additional examples of the present invention. Samples 3 through 8, under the column marked “Composition,” are examples of compositions of the present invention. Samples CE 1 through CE 12 are examples of comparative examples (for each comparative example, the chart details the reason or reasons why the sample failed). FIG. A shows that samples 3 through 8 exhibit the novel stiffness and moisture uptake rate of the present invention. Whereas particular embodiments of the present invention have been described above as examples, it will be appreciated that variations of the details may be made without departing from the scope of the invention. One skilled in the art will appreciate that the present invention can be practiced by other than the disclosed embodiments, all of which are presented in this description for purposes of illustration and not of limitation. It is noted that equivalents of the particular embodiments discussed in this description may practice the invention as well. Therefore, reference should be made to the appended claims rather than the foregoing discussion of examples when assessing the scope of the invention in which exclusive rights are claimed.

What is claimed is:

1. A shaped article comprising an injection molded desiccant plastic composition,
wherein the shaped article is a cylinder with an outside diameter of at least about 8.00 mm, a wall thickness of at least about 0.4 mm and an overall length of at least about 50.0 mm,
wherein the desiccant plastic composition comprises a desiccant, a base polymer of a thermoplastic polymer and an elastomer, and
wherein the resulting shaped article has properties including a moisture uptake rate of at least about 20 mg in 24 hour measured by the Desiccant Rate of Absorption Test Procedure and of a stiffness of at least about 25 Newtons measured by the Mechanical Resistance Control test method.

2. The shaped article of claim 1 wherein the thermoplastic is high density polyethylene having a tensile strength at yield of at least about 25 MPa measured using ISO 527-2 and wherein the desiccant is silica gel.

3. The shaped article of claim 2 wherein the loading of the desiccant can range from about 30 to about 50% (weight).

4. The shaped article of claim 3 wherein the elastomer is EVA co-polymer.

5. The shaped article of claim 4 wherein the shaped article is about 0.10-0.15 mm, wall thickness of about 0.2-0.4 mm and maintains mechanical tolerances to about +−0.02-0.04 mm.
